(19) United States
(12) Patent Application Publication
(10) Pub. No.: US 2007/0098878 A1
(43) Pub. Date: May 3, 2007

(54) Wave-coating method and associated apparatus

(76) Inventor: Hans-Gerhard Burzele, Herbrechtingen (DE)

Correspondence Address: OSRAM SYLVANIA INC, 100 ENDICOTT STREET, DANVERS, MA, 01923, US

(21) Appl. No.: 11/585,951

(22) Filed: Oct. 25, 2006

(30) Foreign Application Priority Data
Oct. 27, 2005 (DE) 20 2005 016 897.1

(51) Int. Cl. B05D 5/06; B05C 5/00

(52) U.S. Cl. 427/64; 118/300

(57) ABSTRACT

A wave-coating method and associated apparatus for wetting a surface of a lamp part in the form of a plate, with a suspension. The apparatus has a feed apparatus for supplying the suspension, and an outlet-flow apparatus for carrying away an outflowing part of the suspension, and, finally, a holding apparatus for holding the feed, the outlet-flow apparatus, and the lamp part. The lamp part and holding apparatus are connected to one another during the wetting process such that a cavity is formed between them. The wave-coating apparatus is designed such that the suspension enters the cavity via the feed apparatus and emerges from the cavity via the outlet-flow apparatus.

### TECHNICAL FIELD

The present invention relates to a wave-coating method and to an associated wave-coating apparatus for wetting a lamp part with a suspension.

### BACKGROUND ART

Lamp parts are often coated with a suspension during their production. A suspension such as this may, for example, be a reflector or a fluorescent coating, which is applied to specific lamp parts, in particular to the inner surface of fluorescent lamps. For this purpose, a discharge vessel tube of a fluorescent lamp that is to be coated is normally positioned obliquely, so that the suspension can flow through the tube, and can wet it in the process. In order to achieve a uniform layer thickness, the fluorescent tube is rotated about its longitudinal axis during this process. Some of the suspension thus remains on the inner surface of the fluorescent tube, and forms the fluorescent coating.

By way of example, screen-printing apparatuses or spraying apparatuses may be used to wet lamp parts which are in the form of plates. In the case of screen printing, a screen is placed over the surface to be wetted, through which the suspension is forced by means of a wiper, for example a squeegee. In the case of spraying, the suspension is sprayed onto the surface to be wetted, by means of a spraying apparatus.

Spraying can be used for shaped lamp parts in the form of plates. A lamp part in the form of a plate is shaped when it is not completely flat but, for example, has raised areas and recessed areas.

### DESCRIPTION OF THE INVENTION

The present invention is based on the technical object of specifying an improved apparatus for wetting a lamp part, which is in the form of a plate, with a suspension.

The invention relates to a wave-coating apparatus for wetting a surface of a lamp part, which is in the form of a plate, with a suspension, which wave-coating apparatus has: a feed apparatus for supplying the suspension, an outlet-flow apparatus for carrying away an outflowing part of the suspension, a holding apparatus for holding the feed and the outlet-flow apparatus and the lamp part to be wetted, with the lamp part and the holding apparatus being connected to one another during the wetting process such that a cavity is formed between them, and with the wave-coating apparatus being designed such that the suspension can enter the cavity via the feed apparatus in order to wet it, and can emerge from the cavity via the outlet-flow apparatus, and with the cavity being designed such that only the area extent of that component of the surface of the lamp part which is to be wetted is wetted by the suspension.

The invention also relates to a method for wetting a lamp part, which is in the form of a plate, with the aid of the abovementioned wave-coating apparatus.

Preferred refinements of the invention will be explained in more detail in the following text.

The inventor has found that the known apparatuses do not always ensure adequate control of the area which is being wetted with the suspension. This can lead to a cleaning problem, if parts of the surface of the lamp part which are not intended to be wetted also come into contact with the suspension. Furthermore, inadequate control can lead to suspension losses and, for example, in the case of spraying, it is possible for some of the suspension to miss the lamp part that is to be wetted.

The invention is based on the discovery that checking of the spatial spreading of the suspension can overcome this problem. Furthermore, an improvement in checking leads to the expectation of a positive effect on some aspects of the use of a wave-coating apparatus according to the invention; for example, it is feasible for the suspension to be supplied to the surface to be wetted at a higher pressure, or to be carried away at a reduced pressure, which can lead to speed advantages.

In the case of a wave-coating apparatus according to the invention, checking of the spatial spreading of the suspension over the arrangement of the lamp part to be wetted and of the holding apparatus is ensured. To be precise, the lamp part and the holding apparatus are connected to one another during the wetting process such that a cavity is formed between them. An inner surface of this cavity in this case corresponds to the surface of the lamp part to be wetted. The wave-coating apparatus may in this case be designed such that those components of the surface of the lamp part which should not be wetted are not adjacent to the cavity.

The wave-coating apparatus is designed in this case such that the suspension can enter the cavity via the feed apparatus in order to wet it, wet the surface to be wetted there, and can then emerge from the cavity via the outlet-flow apparatus. By way of example, the feed apparatus may be a tube which allows the suspension to be introduced into the cavity through, for example, a cutout in the holding apparatus. The outlet-flow apparatus may be a corresponding tube, through which the suspension can be let out or pumped out again. The holding apparatus may be designed such that it holds the lamp part to be wetted, the feed and the outlet-flow apparatus in such a manner that the suspension actually reaches only those components of the surface of the lamp part which are to be wetted, that is to say this ensures controlled spreading of the suspension.

A wave-coating apparatus according to the invention makes it possible to achieve a number of advantages, in particular in comparison to spraying: spraying beyond lamp parts which are in the form of plates is avoided, so that there is no need, as is otherwise normal, to dispose of as scrap or to recycle any suspension which has been sprayed past the lamp part. The suspension which has been sprayed past that surface of the lamp part which is to be wetted also wets the holding apparatus and any spraying cabin which may be present during the spraying process; there is also no need to clean such inadvertently wetted surfaces. Furthermore, edges at the edge of the lamp parts which are in the form of plates should often be kept free of the suspension. The configuration of the cavity for a wave-coating apparatus according to the invention makes it possible to ensure this.

Since, essentially, only that portion of the suspension which wets the surface to be wetted is consumed in the wave-coating process, the consumption of a wave-coating apparatus according to the invention is relatively low. If the wave-coating apparatus is supplied with the suspension via supply containers, then these can therefore be designed to be smaller than, for example, in the case of a spraying apparatus.

In one preferred embodiment of the invention, the wave-coating apparatus has a seal between the holding apparatus and the lamp part, in order to seal the cavity from the outside. The seal can in this case be placed loosely between the holding apparatus and the lamp part. However, it is also feasible for the seal to be integrated in the holding apparatus, in a fixed form or replaceably. The seal could, for example, be a rubber seal or a foam seal, so that it not only makes it easier to seal the cavity from the outside but can also provide a material-protective contact between the lamp part and the holding apparatus, in a simple manner.

The wave-coating apparatus preferably has a clamping apparatus which clamps the lamp part and the holding apparatus together during the wetting process. A clamping apparatus such as this ensures that they are held together during the wetting process in a mechanically particularly simple manner. Clamping apparatuses can thus frequently also be provided at low cost. For example, it is feasible for the lamp part to be wetted to be placed horizontally on the holding apparatus and for a number of clamping apparatuses then to be fitted at points around the edge of the lamp part, which surround the lamp part and the holding apparatus, and engage in the holding apparatus.

In one preferred embodiment of the invention, the feed apparatus and the outlet-flow apparatus have a common line or common lines. For example, the feed apparatus and the outlet-flow apparatus may have a common tube which is connected to the cavity; the suspension can be introduced into the cavity through this tube, can wet the surface to be wetted there, and can then flow away or be pumped out again. In an embodiment of the invention such as this, those parts which come into contact with the suspension are minimized. This has the advantage that fewer parts to which attention needs to be paid during a suspension change are contaminated with the suspension. In the present example, only one tube would need to be cleaned.

In one preferred embodiment of the invention, the holding apparatus is designed to hold two lamp parts during the wave-coating process such that the cavity is bounded by the two lamp parts and the holding apparatus. In this case as well, those components of the respective lamp parts to be wetted make up a portion of the inner surface of the cavity. The fact that the cavity is now, inter alia, bounded by two lamp parts has the advantage that two lamp parts can be wetted with the suspension at the same time during one wave-coating process. If an attempt is made to form the cavity that is formed by the lamp parts and the holding apparatus using more than two lamp parts, then although more lamp parts can be wetted per wave-coating process, the holding apparatus and the correct configuration of the lamp parts with the holding apparatus become increasingly more complex, however, with the number of lamp parts involved.

The wave-coating apparatus is preferably designed to wet a glass plate. Because of its optical characteristics and stability, glass naturally plays a very important role as a material in lighting technology. An appropriate glass-compatible design of the wave-coating apparatus may be ensured, for example, by means of an appropriately material-protective holding apparatus. For example, this can have a relatively soft seal in order to support the glass. In addition, the attachment of the glass plate to the holding apparatus, for example by a clamping apparatus, can be designed in a corresponding manner to protect the glass, for example by means of elastic contacts.

The wave-coating apparatus is preferably designed to wet a part of the discharge vessel of a flat radiator which is designed for dielectric-barrier discharge lamps. For example, parts of the discharge vessel can be wetted with a fluorescent or reflection suspension. The discharge-vessel components of flat radiators for dielectric-barrier discharge lamps are in the form of plates.

Often, although the lamp parts to be wetted are in the form of plates, they are, in fact, not just flat, but have shapes which differ from a smooth plane. These may, for example, be raised areas or recessed areas with respect to a fictional smooth surface of the lamp part which is in the form of a plate. In the past, uneven lamp parts in the form of plates such as these have been wetted by spraying. A wave-coating apparatus according to the invention can also be designed to wet shaped lamp parts which are in the form of plates such as these, without having the mentioned disadvantages of spraying.

The wave-coating apparatus is preferably not only designed to supply a suspension to the lamp part to be wetted but, in particular, prior to this, also to supply it with a cleaning agent. A cleaning agent such as this makes it possible, for example, to remove contamination remaining from the production process.

A further preferred embodiment of the invention is designed to supply the surface to be wetted with an adhesion promoter, before the application of a fluorescent material and after any cleaning. The surface to be wetted can thus be wetted with a suspension whose adhesion is otherwise poor.

The preceding description and the following description of the individual features relate to the apparatus category as well as a method which corresponds to the invention, without this also being explicitly mentioned in detail.

Fundamentally, the invention thus also relates to a method for wetting a surface of a lamp part, which is in the form of a plate, with a suspension by means of a wave-coating apparatus, having the following steps: the suspension is supplied by means of a feed apparatus, an outflowing part of the suspension is carried away by means of an outlet-flow apparatus, and the feed and the outlet-flow apparatus and the lamp part to be wetted are held by a holding apparatus, with the lamp part and the holding apparatus being connected to one another during the wave-coating process such that a cavity is formed between them, and with the wave-coating process being carried out such that the suspension can enter the cavity via the feed apparatus in order to wet it, and can emerge from the cavity via the outlet-flow apparatus, and with the cavity being designed such that only the area extent of that component of the surface of the lamp part which is to be wetted is wetted by the suspension.

The invention furthermore relates to a method in which the lamp part to be wetted is a glass plate. Furthermore, the invention also relates in principle to a method in which the lamp part to be wetted is a part of a flat radiator which is designed for dielectric discharges.

In addition, the invention also relates to a method in which the lamp part to be wetted has raised areas and recessed areas.

Furthermore, the invention also relates to a method in which a wave-coating apparatus according to the invention is used to supply a cleaning agent to the surface to be wetted of the lamp part which is in the form of a plate. Furthermore, the invention also relates to a method in which a wave-coating apparatus according to the invention is used to supply an adhesion promoter to the surface to be wetted of the lamp part which is in the form of a plate.

Finally, the invention also relates to the above and following refinements, which are implicitly also explained for these methods.

### BRIEF DESCRIPTION OF THE DRAWINGS

The invention will be explained in more detail in the following text with reference to exemplary embodiments. The individual features disclosed in this case may also be significant to the invention in other combinations. In the figures:

FIG. 1 shows a first wave-coating apparatus according to the invention, in which the holding apparatus is designed to hold a flat glass plate. A detail is once again illustrated in an enlarged form.

FIG. 2 shows a second wave-coating apparatus according to the invention, which is designed to hold two flat glass plates. In addition, a detail is illustrated in an enlarged form.

FIG. 3 shows a variant of the wave-coating apparatus from FIG. 1.

FIG. 4 shows a variant of the wave-coating apparatus from FIG. 2.

### BEST MODE FOR CARRYING OUT THE INVENTION

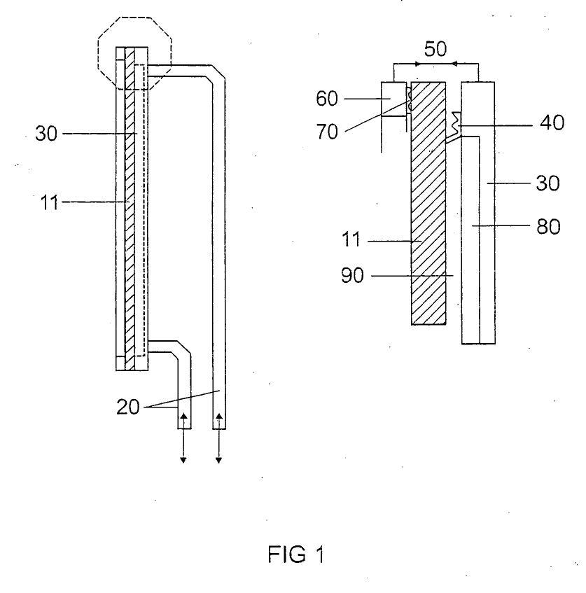

FIG. 1 shows a wave-coating apparatus according to the invention from the side. A planar glass plate 11 is attached to a holding apparatus 30. Tubes 20 (feed apparatus and outlet-flow apparatus) are passed through the holding apparatus 30. A suspension can be pumped in and out through the tubes 20. In this exemplary embodiment, the suspension is supplied through the tube on the right, and can flow away again through the tube on the left. The tubes 20 are respectively connected to a pump (not shown) and to a supply container for the suspension (not shown), in this case a fluorescent material suspension. The holding apparatus 30 is in this case formed from a number of parts. A base plate 80 which is part of the holding apparatus 30 is located on the right of the glass plate 11, and a part of a holding frame 60, which is also a part of the holding apparatus 30, can be seen in the detail view to the left of the glass plate 11. The parts 60, 80 of the holding apparatus 30 are held together with the glass plate 11 located between them by a mechanical clamp 50. In order to ensure that the holding frame 60 does not damage the glass plate 11 in this case, an elastic rubber stopper 70 is located between the holding frame 60 and the glass plate 11. A cavity 90 is formed between the glass plate 11 and the right-hand part 80 of the holding apparatus 30. This cavity 90 is sealed from the outside by a seal 40, and the suspension is pumped into this cavity 90 in order to wet the surface.

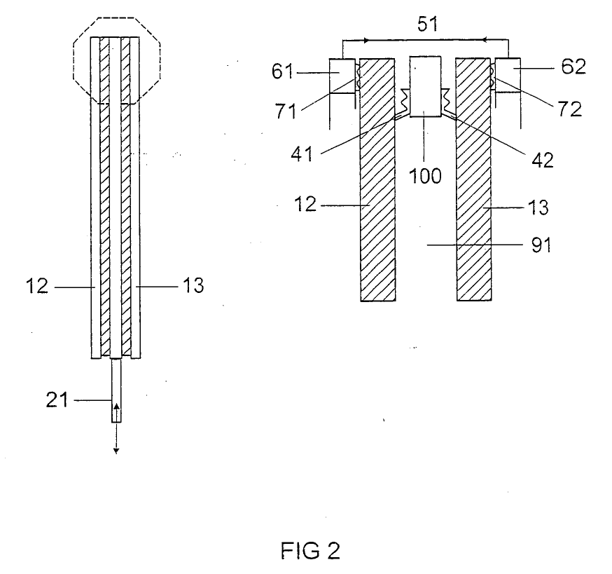

FIG. 2 shows one embodiment of the invention, which is designed to hold two lamp parts which are in the form of plates at the same time, and to carry out a wave-coating process on them. Glass plates 12 and 13, respectively, can be seen on the left and right in the overview drawing. At the bottom in the center, the suspension can first of all be supplied and can then run away again through one and the same tube 21. This tube 21 is also connected by a pump to a suspension supply (not shown). In the detail drawing, a cavity 91 can be seen, which is bounded on the left and right by the two glass plates 12 and 13, respectively, and by an inner holding frame 100. Seals 41 and 42 are used to seal the cavity 91 from the outside, and are located between the inner holding frame 100 and the respective glass plates 12 and 13. This cavity 91 is filled, and emptied again as well, through the tube 21. In a similar manner to that in FIG. 1, the holding apparatus is once again also composed of two components, the inner holding frame 100 and the respective outer holding frame 61 or 62. In a similar manner to that in FIG. 1, a clamping apparatus 51 ensures that the structure is held together. In this case, the respective outer part 61 or 62 of the holding apparatus, which surrounds the glass plates 12 and 13, are pressed together, so that the glass plates 12 and 13 are indirectly clamped to the inner holding frame 100 via the seals 41 and 42. In order to protect the glass plates 12 and 13 against damage caused by the outer holding frames 61 and 62, elastic rubber stoppers 71 and 72 are fitted between the outer holding frames 61 and 62 and the glass plates 12 and 13.

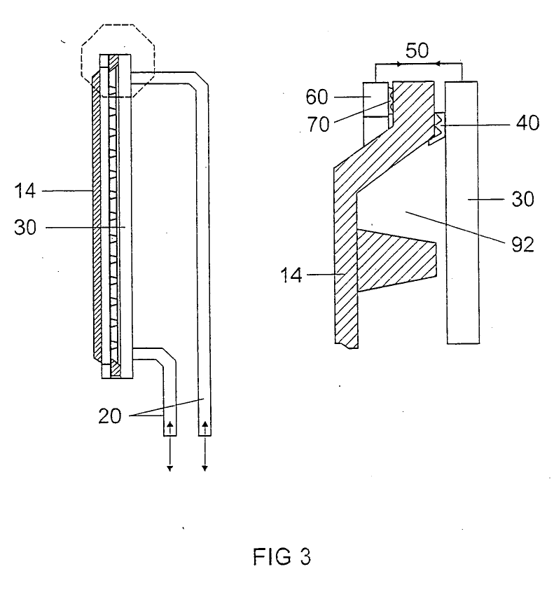

FIG. 3 shows an embodiment of the invention corresponding to that shown in FIG. 1, with the difference that the wave-coating apparatus is in this case designed to carry out a wave-coating process on a shaped glass plate 14. The pronounced three-dimensional structures of the glass plate 14, which also govern the internal shape of the cavity 92, can be seen. The glass plate 14 is part of a flat radiator, and is described in more detail in a comparable form in DE 100 48 187.

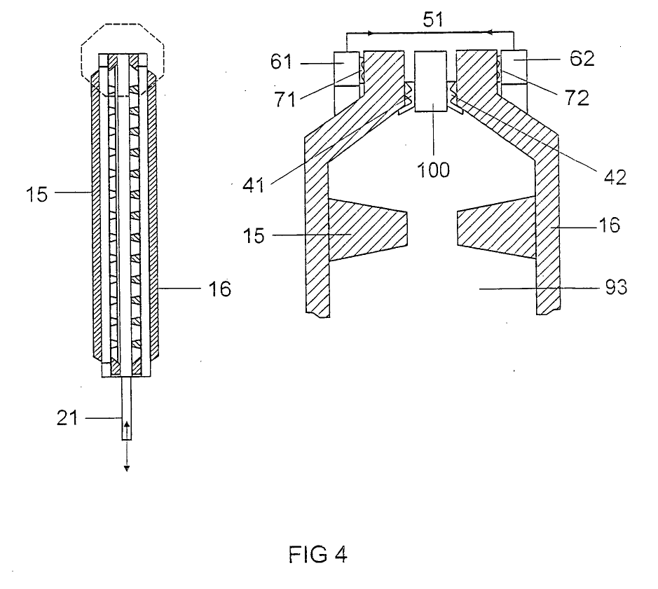

FIG. 4 shows a variant of the wave-coating apparatus from FIG. 2, which is designed to hold and to carry out a wave-coating process on two glass plates 15 and 16 which are not flat. In this case as well, the internal shape of the cavity 93 is governed to a quite considerable extent by the shape of the glass plates 15 and 16.

A wave-coating process will now be described using the example of the embodiment shown in FIG. 4. The seals 41 and 42 are fitted with a detachable adhesive by machine on the inner holding frame 100. The shaped glass plates 15 and 16 are held by a robot on the inner holding frame 100. The outer parts 61 and 62 of the holding apparatus are held by machine on the glass plates 15 and 16 in such a way that the clamping apparatus 51 can be placed by machine around the edge of the glass plates, so that it can exert pressure on the glass plates 15 and 16. As soon as the clamping apparatus has been positioned such that the elastic rubber stoppers 71 and 72, the seals 41 and 42, the glass plates 15 and 16 and the holding frame 100 lie on one line, the clamping apparatus is closed such that it works closely on them, and holds them all together.

First of all, a cleaning agent, in this case a lye, is pumped into the cavity 93 through the tube 21 at three bar. After ten seconds, the lye is sucked out at just one bar. To ensure that no vacuum is formed in the cavity, valve flaps are located in the inner holding frame 100, and are opened in the event of outward suction. During the short time for which the cleaning agent remains in the cavity, it can act on the glass surfaces. During this process, the glass surfaces have any contamination which may be located on them removed. The tube 21 is then connected via a pump to a supply container for an adhesion promoter. This is also introduced into the cavity 93 for a short time, and pumped out again, in a similar manner to the cleaning agent. However, it is pumped out again immediately after the cavity 93 has been filled, since no time is required for it to act. Finally, the suspension is pumped into the cavity 93 via the tube 21 at three bar, and is immediately pumped out again at just one bar. The tube 21 may be flexible, and can be quickly connected via valves to the respectively currently required materials (cleaning agent, adhesion promoter or fluorescent material).

1. A wave-coating apparatus for wetting a surface of a lamp part, which is in the form of a plate, with a suspension,
which wave-coating apparatus has:
a feed apparatus for supplying the suspension,
an outlet-flow apparatus for carrying away an outflowing part of the suspension,
a holding apparatus for holding the feed and the outlet-flow apparatus and the lamp part to be wetted, with the lamp part and the holding apparatus being connected to one another during the wetting process such that a cavity is formed between them,
and with the wave-coating apparatus being designed such that the suspension can enter the cavity via the feed apparatus in order to wet it, and can emerge from the cavity via the outlet-flow apparatus,
and with the cavity being designed such that only the area extent of that component of the surface of the lamp part which is to be wetted is wetted by the suspension.

2. The wave-coating apparatus as claimed in claim 1, which has a seal between the holding apparatus and the lamp part, in order to seal the cavity from the outside.

3. The wave-coating apparatus as claimed in claim 1, which has a detachable clamping apparatus, which clamps the lamp part and the holding apparatus together during the wetting process.

4. The wave-coating apparatus as claimed in claim 1, in which the feed apparatus and the outlet-flow apparatus have a common line.

5. The wave-coating apparatus as claimed in claim 1, in which the holding apparatus is designed to hold two lamp parts during the wave-coating process such that the cavity is bounded by the two lamp parts and the holding apparatus.

6. The wave-coating apparatus as claimed in claim 1, in which the lamp part to be wetted is a glass plate.

7. The wave-coating apparatus as claimed in claim 1, in which the lamp part to be wetted is a part of the discharge vessel of a flat radiator designed for dielectric-barrier discharge lamps.

8. The wave-coating apparatus as claimed in claim 1, in which the lamp part to be wetted has raised areas and recessed areas.

9. The wave-coating apparatus as claimed in claim 1, which is designed to wet one surface of a lamp part, which is in the form of a plate, with a cleaning agent.

10. The wave-coating apparatus as claimed in claim 1, which is designed to wet one surface of a lamp part, which is in the form of a plate, with an adhesion promoter.

11. A wave-coating method for wetting a surface of a lamp part, which is in the form of a plate, with a suspension by means of a wave-coating apparatus as claimed in at least one of the preceding claims, having the following steps: the suspension is supplied by means of a feed apparatus, an outflowing part of the suspension is carried away by means of an outlet-flow apparatus, and the feed and the outlet-flow apparatus and the lamp part to be wetted are held by a holding apparatus, with the lamp part and the holding apparatus being connected to one another during the wave-coating process such that a cavity is formed between them, and with the wave-coating process being carried out such that the suspension can enter the cavity via the feed apparatus in order to wet it, and can emerge from the cavity via the outlet-flow apparatus, and with the cavity being designed such that only the area extent of that component of the surface of the lamp part which is to be wetted is wetted by the suspension.

12. The method as claimed in claim 11, in which the lamp part to be wetted is a glass plate.

13. The method as claimed in claim 11, in which the lamp part to be wetted is a part of a flat radiator designed for dielectric discharges.

14. The method as claimed in claim 11, in which the lamp part to be wetted has raised areas and recessed areas.

15. The method as claimed in claim 11, in which the surface to be wetted of the lamp part which is in the form of a plate is supplied with a cleaning agent.

16. The method as claimed in claim 11, in which the surface to be wetted of the lamp part which is in the form of a plate is supplied with an adhesion promoter.

17. The method as claimed in claim 15, in which the surface to be wetted of the lamp part which is in the form of a plate is supplied with an adhesion promoter.
